(19) United States
(12) Patent Application Publication
(10) Pub. No.: US 2015/0238984 A1
(43) Pub. Date: Aug. 27, 2015

(54) Showerhead with spray mode selecting function

(71) Applicant: Ransom Man Pan LEE, KOWLOON (HK)

(72) Inventor: Ransom Man Pan LEE, KOWLOON (HK)

(21) Appl. No.: 14/190,027

(22) Filed: Feb. 25, 2014

(51) Int. Cl. B05B 1/16; E03C 1/04

(52) U.S. Cl. CPC B05B 1/169; E03C 1/0408

(57) ABSTRACT

The present invention is a showerhead with spray mode selecting function which includes a handle portion and a showerhead portion. The handle portion is disposed with a mode selecting means which couples with a pushrod. The showerhead portion comprises an actuating means, a limiting disc and a diverting member. The diverting member has a plurality of water chambers, each of which includes a chamber magnet attracted by the actuating magnet to move together with the controlling member between a blocking position where water is blocked by the controlling member from flowing from the water chamber cavity to the water outlet and a non-blocking position where water is allowed to flow from the water chamber cavity to the water outlet.

### BACKGROUND OF THE INVENTION

The present invention relates to showerheads and more particularly pertains to a showerhead with spray mode selecting function.

There are a number of showerheads available in the marketplace which provide spray mode selecting function. A user could select different spray modes such as massage mode, mist mode, pulsating mode and so forth by rotating an annular ring disposed at the showerhead. However, when the user is in the shower and water spraying out from the showerhead, it is often difficult for the user to use his wet hands to rotate the annular ring. Besides, as the user has to face the showerhead to make sure the annular ring is rotated to the right position, the rotation action usually results in water being splashed to the user's face, which is undesirable for the user.

### BRIEF SUMMARY OF THE INVENTION

In view of the aforesaid disadvantages now present in the prior art, the present invention provides a showerhead with spray mode selecting function which provides a convenient mechanism for a user to select different spray modes.

To attain this, the present invention generally comprises a handle portion and a showerhead portion. The handle portion provides a water passage for water to flow from a water source to the showerhead portion, and is disposed with a mode selecting means which couples with a first end of a pushrod. The showerhead portion comprises an actuating means, a limiting disc and a diverting member.

The actuating means is actuated by a second end of the pushrod to rotate around an axis between a first position and a second position, and is biased by a first biasing means towards the first position.

The limiting disc is actuated by the actuating means to rotate around the axis and disposed with an actuating magnet on a top side thereof. Rotation of the actuating means displaces the actuating magnet among a plurality of evenly spaced predefined positions; each of the predefined positions is associated with one spray mode, and distance between the adjacent predefined positions corresponds to distance between the first position and the second position of the actuating means.

The diverting member which comprises a water inlet which is in communication with the water passage, a diverting member cavity which is in communication with the water inlet, a plurality of water chambers sealed from each other.

Each of the water chamber comprises a water inlet pore which is in communication with the diverting member cavity, a water chamber cavity which is in communication with the water inlet pore, a water outlet which is in communication with one or more specific water channels for delivering water out from the showerhead in a specific spray mode, a controlling member which is in selective communication with the water chamber cavity and the water outlet, and a chamber magnet.

The chamber magnet is fixedly secured to the controlling member and attracted by the actuating magnet to move together with the controlling member between a blocking position where water is blocked by the controlling member from flowing from the water chamber cavity to the water outlet and a non-blocking position where water is allowed to flow from the water chamber cavity to the water outlet. A second biasing means biases the chamber magnet towards the blocking position.

In one embodiment, the mode selecting means comprises a slide button exposed on an outer surface of the handle portion, and a sliding plate fixedly engaged with the slide button and disposed inside the handle portion; the sliding plate has an end which couples with the first end of the pushrod; sliding the slide button forward moves the sliding plate forward towards the pushrod and thus push the pushrod forward.

In another embodiment, the mode selecting means comprises a push button exposed on an outer surface of the handle portion, a first connecting rod, a second connecting rod and a spring; the first connecting rod has a first end which is pivotally connected at a pivot point with a first end of the second connecting rod; the first connecting rod has a second end which is fixedly disposed inside the handle portion; the second connecting rod has a second end which is movably and abuts against the first end of the pushrod; the push button couples with the pivot point so that depression of the push button causes the second end of the second connecting rod to move forward towards the pushrod and thus push the pushrod forward; the spring is disposed inside the handle portion and abuts against a bottom side of the push button to bias the push button towards a non-depressed position.

In one embodiment, the actuating means is in form of a ratchet wheel with an actuating rod extended therefrom; the actuating rod has a free end which abuts against the second end of the pushrod; the ratchet wheel is disposed with a plurality of uniform ratchet teeth, each of the ratchet teeth is asymmetrical with an apex and a root. The first biasing means is a spring wound around a bottom side of the ratchet wheel.

In one embodiment, the limiting disc has a bottom side which is evenly disposed with a plurality of sloping slots corresponding to the plurality of ratchet teeth; each of the sloping slots has a deep end which protrudes upward to the top side of the limiting disc and a shallow end; each of the sloping slots engages with one of the ratchet teeth such that the apex of the ratchet tooth abuts against the deep end of the sloping slot.

In one embodiment, the top side of the limiting disc is fixedly disposed with an actuating magnet seat for receiving the actuating magnet.

In one embodiment, the diverting member is formed by an upper diverting member and a lower diverting member. The water inlet is provided at the upper diverting member. The upper diverting member and the lower diverting member are disposed with walls for defining the diverting chamber cavity and the water chamber cavity of the water chambers. A first intermediate diverting member is provided between the upper diverting member and the lower diverting member for water sealing each of the water chambers and for supporting a second intermediate diverting member in each of the water chambers. The water inlet pore and the water outlet are disposed in the second intermediate diverting member. The upper diverting member is provided with an upward recess for receiving the chamber magnet in each of the water chambers. The second biasing means is a spring disposed in the upward recess.

The operation of the present invention is as follows:

To change from a first spray mode to a second spray mode, the user first actuates the mode selecting means, either by pushing the slide button forward or by depressing the push button. The first end of the pushrod which couples with the mode selecting means is then pushed forward, and the second end of the pushrod then pushes the actuating rod of the ratchet wheel forward, thus driving the ratchet wheel to rotate in a first direction from the first position to the second position; since the apex of each of the ratchet teeth abuts against the deep end of each of the sloping slot, the rotation of the ratchet wheel in the first direction pushes the limiting disc to rotate in the first direction as well, and thus the actuating magnet also rotates in the first direction from a first predefined position associated with the first spray mode to a second predefined position associated with the second spray mode.

By the time when the actuating means reaches the second position, the user should have released the mode selecting means, and so there is no external force to push the pushrod forward. As the actuating means is biased by the first biasing means towards the first position, at this time the actuating means rotates in the second direction towards the first position; the apex of each of the ratchet teeth leaves the deep end of each of the sloping slots and abuts against the deep end of the next sloping slot when the actuating means returns to the first position. The rotation of the actuating means also pushes the pushrod rearward by means of the actuating rod, thus driving the mode selecting means to return to the original position. At this time, the actuating magnet is displaced from the first predefined position associated with the first spray mode to the second predefined position associated with the second spray mode.

As water enters the water inlet from the water passage, water enters the diverting member cavity and thereafter enters the water chamber cavity of each of the water chambers via the corresponding water inlet pore. As the user actuates the mode selecting means to change from the first spray mode to the second spray mode, the actuating magnet is displaced from the first predefined position associated with the first spray mode to the second predefined position associated with the second spray mode. At this time, the actuating magnet is positioned on top of the second water chamber and thus attract the chamber magnet of the second water chamber to move upwards from the blocking position to the non-blocking position; therefore, among the plurality of the water chambers, water could only flow from the water chamber cavity to the water outlet of the second water chamber. In all other water chambers, water is blocked by their corresponding controlling members from flowing from their corresponding water chamber cavities to their corresponding water outlets. Water therefore flows from the second water chamber to the one or more specific water channels for delivering water out from the showerhead in the second spray mode. The mechanisms for delivering water out from the showerhead in different spray modes from one or more specific water channels are widely available in the prior art and are therefore not described in detail herein.

To change from the second spray mode to a third spray mode, the user actuates the mode selecting means again, so that the actuating magnet is displaced from the second predefined position to a third predefined position associated with the third spray mode. At this time, the actuating magnet is positioned on top of the third water chamber. As the chamber magnet of the second water chamber is no longer attracted by the actuating magnet, it moves from the non-blocking position to the blocking position. The chamber magnet in the third water chamber is attracted by the actuating magnet to move upwards from the blocking position to the non-blocking position, thus allowing water to flow from the water chamber cavity to the water outlet and then to the one or more specific water channels for delivering water out from the showerhead in the third spray mode.

### BRIEF DESCRIPTION OF THE DRAWINGS

FIG. 1 is a cross sectional view of the first embodiment of the present invention.

FIG. 2a is a perspective view illustrating the connection of the pushrod and the actuating means of the first embodiment.

FIG. 2b is another perspective view illustrating the connection of the pushrod and the actuating means of the first embodiment.

FIG. 3 is a partial perspective sectional view of the showerhead portion of the first embodiment.

FIG. 4a is a perspective view of the actuating means of the first embodiment.

FIG. 4b is another perspective view of the actuating means of the first embodiment.

FIG. 5 is a perspective view illustrating the connection of the actuating means and the first biasing means of the first embodiment.

FIG. 6 is a perspective view illustrating the top side of the limiting disc of the first embodiment.

FIG. 7 is a perspective view illustrating the bottom side of the limiting disc of the first embodiment.

FIG. 8 is a perspective view illustrating the connection of the actuating means and the upper diverting member of the first embodiment.

FIG. 9 is a perspective view illustrating the top side of the upper diverting member of the first embodiment.

FIG. 10 is a perspective view illustrating the bottom side of the upper diverting member of the first embodiment.

FIG. 11 is a perspective view illustrating the top side of the lower diverting member of the first embodiment.

FIG. 12 is a perspective view illustrating the bottom side of the lower diverting member of the first embodiment.

FIG. 13 is a cross sectional view of the second embodiment of the present invention.

FIG. 14 is a perspective view illustrating the connection of the push button, the first connecting rod, the second connecting rod, the spring and the actuating means of the second embodiment.

### DETAILED DESCRIPTION OF THE INVENTION

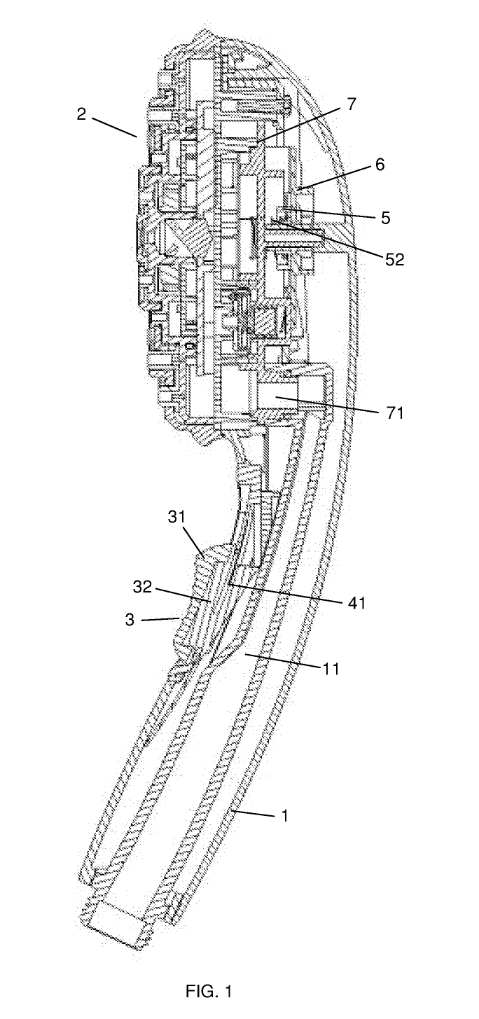

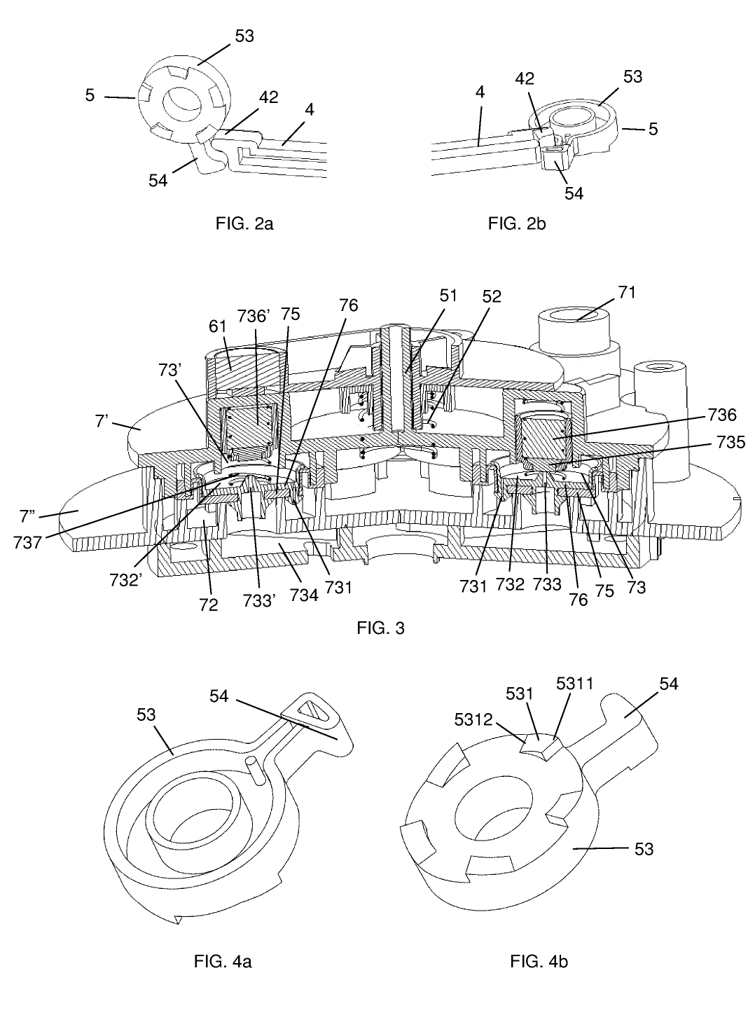

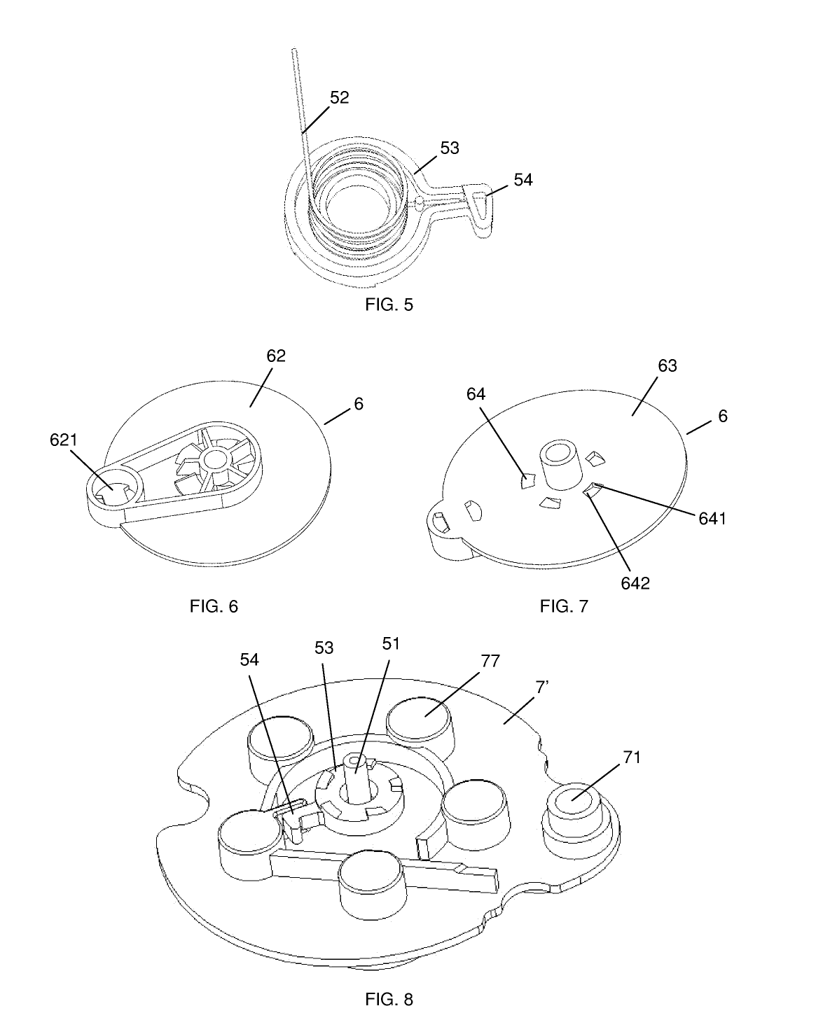

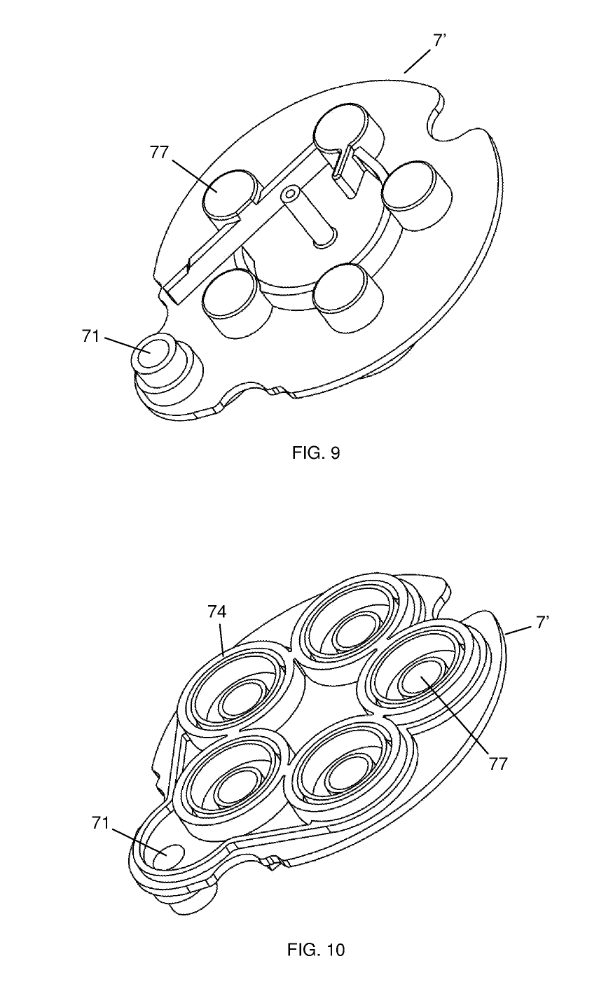

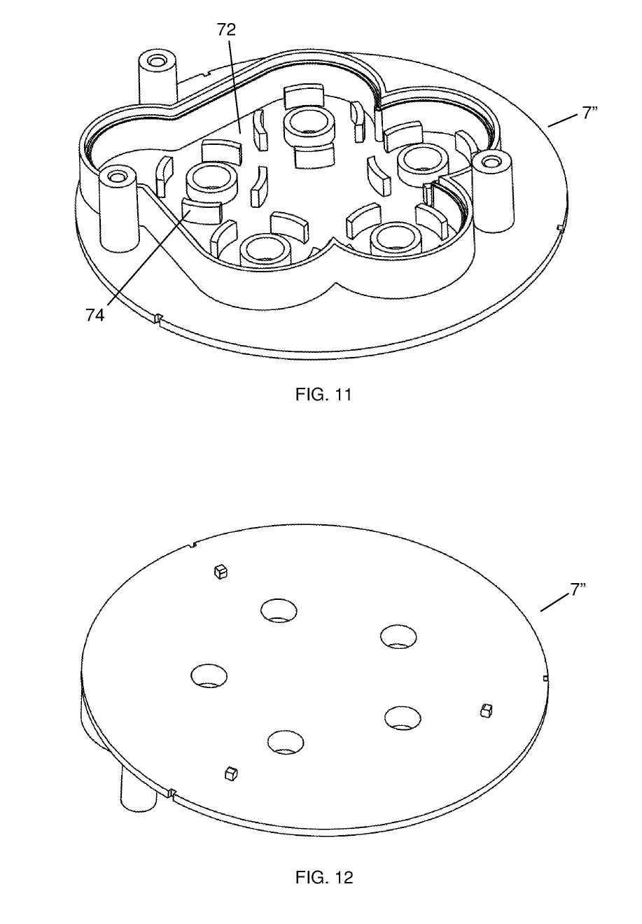

As illustrated in FIGS. 1-12, the first embodiment of the present invention generally comprises a handle portion 1 and a showerhead portion 2. The handle portion 1 provides a water passage 11 for water to flow from a water source (not shown) to the showerhead portion 2, and is disposed with a mode selecting means 3 which couples with a first end 41 of a pushrod 4. The showerhead portion 2 comprises an actuating means 5, a limiting disc 6 and a diverting member 7.

In this embodiment, the mode selecting means 3 comprises a slide button 31 exposed on an outer surface of the handle portion 1, and a sliding plate 32 fixedly engaged with the slide button 31 and disposed inside the handle portion 1. The sliding plate 32 has an end which couples with the first end 41 of the pushrod 4. Sliding the slide button 31 forward moves the sliding plate 32 forward towards the pushrod 4 and thus push the pushrod 4 forward.

The actuating means 5 is actuated by a second end 42 of the pushrod 4 to rotate around an axis 51 between a first position and a second position, and is biased by a first biasing means 52 towards the first position. In this embodiment, the actuating means 5 is in form of a ratchet wheel 53 with an actuating rod 54 extended therefrom; the actuating rod 54 has a free end 541 which abuts against the second end 42 of the pushrod 4. The ratchet wheel 53 is disposed with five uniform ratchet teeth 531, and each of the ratchet teeth 531 is asymmetrical with an apex 5311 and a root 5312. The first biasing means 52 is a spring wound around a bottom side of the ratchet wheel 53.

The limiting disc 6 is actuated by the actuating means 5 to rotate around the axis 51. An actuating magnet 61 is disposed on a top side 62 of the limiting disc 6. Rotation of the actuating means 5 displaces the actuating magnet 61 among five evenly spaced predefined positions; each of the predefined positions is associated with one spray mode, and distance between the adjacent predefined positions corresponds to distance between the first position and the second position of the actuating means 5. In this embodiment, the limiting disc 6 has a bottom side 63 which is evenly disposed with five sloping slots 64 corresponding to the five ratchet teeth 531. Each of the sloping slots 64 has a deep end 641 which protrudes upward to the top side 62 of the limiting disc 6 and a shallow end 642. Each of the sloping slots 64 engages with one of the ratchet teeth 531 such that the apex 5311 of the ratchet tooth 531 abuts against the deep end 641 of the sloping slot 64. The top side 62 of the limiting disc 6 is fixedly disposed with an actuating magnet seat 621 for receiving the actuating magnet 61.

The diverting member 7 comprises a water inlet 71 which is in communication with the water passage 11, a diverting member cavity 72 which is in communication with the water inlet 71, and five water chambers 73 sealed from each other. Each of the water chambers 73 comprises a water inlet pore 731 which is in communication with the diverting member cavity 72, a water chamber cavity 732 which is in communication with the water inlet pore 731, a water outlet 733 which is in communication with one or more specific water channels 734 for delivering water out from the showerhead in a specific spray mode, a controlling member 735 which is in selective communication with the water chamber cavity 732 and the water outlet 733, and a chamber magnet 736. The chamber magnet 736 is fixedly secured to the controlling member 735 and attracted by the actuating magnet 61 to move together with the controlling member 735 between a blocking position where water is blocked by the controlling member 735 from flowing from the water chamber cavity 732 to the water outlet 733 and a non-blocking position where water is allowed to flow from the water chamber cavity 732 to the water outlet 733. A second biasing means 737 biases the chamber magnet 736 towards the blocking position. In this embodiment, the diverting member 7 is formed by an upper diverting member 7′ and a lower diverting member 7″. The water inlet 71 is provided at the upper diverting member 7′. The upper diverting member 7′ and the lower diverting member 7″ are disposed with walls 74 for defining the diverting chamber cavity 72 and the water chamber cavity 732 of the water chambers 73. A first intermediate diverting member 75 is provided between the upper diverting member 7′ and the lower diverting member 7″ for water sealing each of the water chambers 73 and for supporting a second intermediate diverting member 76 in each of the water chambers 73. The water inlet pore 731 and the water outlet 733 are disposed in the second intermediate diverting member 76. The upper diverting member 7′ is provided with an upward recess 77 for receiving the chamber magnet 736 in each of the water chambers 73. The second biasing means 737 is a spring disposed in the upward recess 77.

The operation of the present embodiment is as follows:

To change from a first spray mode to a second spray mode, the user first actuates the mode selecting means 3 by pushing the slide button 31 forward. The first end 41 of the pushrod 4 which couples with the mode selecting means 3 is then pushed forward, and the second end 42 of the pushrod 4 then pushes the actuating rod 54 of the ratchet wheel 53 forward, thus driving the ratchet wheel 53 to rotate in a first direction from the first position to the second position; since the apex 5311 of each of the ratchet teeth 531 abuts against the deep end 641 of each of the sloping slot 64, the rotation of the ratchet wheel 53 in the first direction pushes the limiting disc 6 to rotate in the first direction as well, and thus the actuating magnet 61 also rotates in the first direction from a first predefined position associated with the first spray mode to a second predefined position associated with the second spray mode.

By the time when the actuating means 5 reaches the second position, the user should have released the mode selecting means 3, and so there is no external force to push the pushrod 4 forward. As the actuating means 5 is biased by the first biasing means 52 towards the first position, at this time the actuating means 5 rotates in the second direction towards the first position; the apex 5311 of each of the ratchet teeth 531 leaves the deep end 641 of each of the sloping slots 64 and abuts against the deep end 641 of the next sloping slot 64 when the actuating means 5 returns to the first position. The rotation of the actuating means 5 also pushes the pushrod 4 rearward by means of the actuating rod 54, thus driving the mode selecting means 3 to return to the original position. At this time, the actuating magnet 61 is displaced from the first predefined position associated with the first spray mode to the second predefined position associated with the second spray mode.

As water enters the water inlet 71 from the water passage 11, water enters the diverting member cavity 72 and thereafter enters the water chamber cavity 732 of each of the water chambers 73 via the corresponding water inlet pore 731. As the user actuates the mode selecting means 3 to change from the first spray mode to the second spray mode, the actuating magnet 61 is displaced from the first predefined position associated with the first spray mode to the second predefined position associated with the second spray mode. At this time, the actuating magnet 61 is positioned on top of the second water chamber 73′ and thus attract the chamber magnet 736′ of the second water chamber 73′ to move upwards from the blocking position to the non-blocking position; therefore, among the five water chambers 73, water could only flow from the water chamber cavity 732′ to the water outlet 733′ of the second water chamber 73′. In all other water chambers 73, water is blocked by their corresponding controlling members 735 from flowing from their corresponding water chamber cavities 732 to their corresponding water outlets 733. Water therefore flows from the second water chamber 73′ to the one or more specific water channels 734 for delivering water out from the showerhead in the second spray mode. The mechanisms for delivering water out from the showerhead in different spray modes from one or more specific water channels are widely available in the prior art and are therefore not described in detail herein.

To change from the second spray mode to a third spray mode, the user actuates the mode selecting means 3 again, so that the actuating magnet 61 is displaced from the second predefined position to a third predefined position associated with the third spray mode. At this time, the actuating magnet 61 is positioned on top of the third water chamber 73. As the chamber magnet 736′ of the second water chamber 73′ is no longer attracted by the actuating magnet 61, it moves from the non-blocking position to the blocking position. The chamber magnet 736 in the third water chamber 73 is attracted by the actuating magnet 61 to move upwards from the blocking position to the non-blocking position, thus allowing water to flow from the water chamber cavity 732 to the water outlet 733 and then to the one or more specific water channels 734 for delivering water out from the showerhead in the third spray mode.

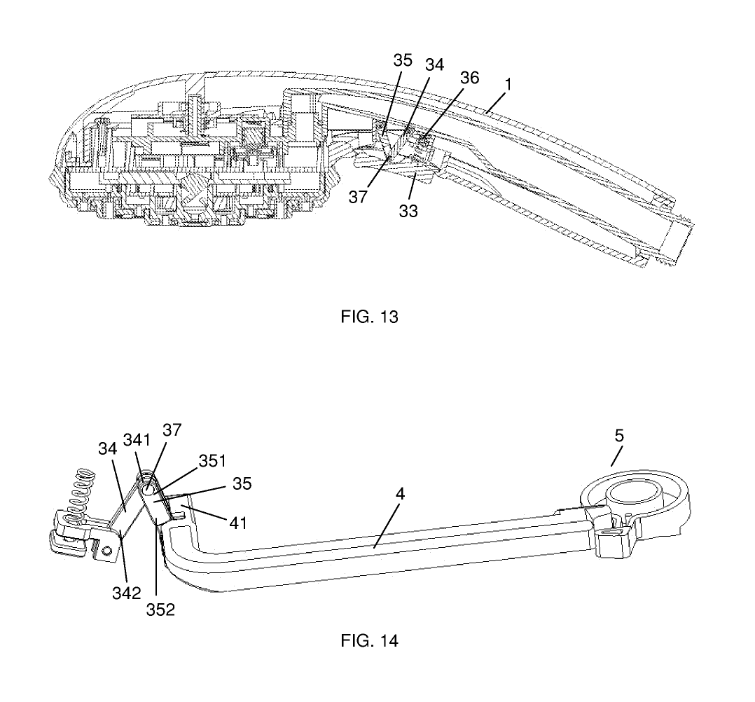

FIGS. 13-14 illustrate the second embodiment of the present invention. The second embodiment is substantially similar to the first embodiment except for the following: In the second embodiment, the mode selecting means 3 comprises a push button 33 exposed on an outer surface of the handle portion 1, a first connecting rod 34, a second connecting rod 35 and a spring 36. The first connecting rod 34 has a first end 341 which is pivotally connected at a pivot point 37 with a first end 351 of the second connecting rod 35; the first connecting rod 34 has a second end 342 which is fixedly disposed inside the handle portion 1; the second connecting rod 35 has a second end 352 which is movably and abuts against the first end 41 of the pushrod 4. The push button 33 couples with the pivot point 37 so that depression of the push button 33 causes the second end 352 of the second connecting rod 35 to move forward towards the pushrod 4 and thus push the pushrod 4 forward. The spring 36 is disposed inside the handle portion 1 and abuts against a bottom side of the push button 33 to bias the push button 33 towards a non-depressed position.

As the user depresses the push button 33, the second end 352 of the second connecting rod 35 are driven to move forward, thus pushing the first end 41 of the pushrod 4 forward to drive the rotation of the actuating means 5. By the time when the actuating means 5 reaches the second position, the user should have released the push button 33, and the spring 36 biases the push button 33 towards the non-depressed position. The rotation of the actuating means 5 to the first position pushes the pushrod 4 rearward, thus driving the second end 352 of the second connecting rod 35 to return to the original position.

The above embodiments are preferred embodiments of the present invention. The present invention is capable of other embodiments and is not limited by the above embodiments. Any other variation, decoration, substitution, combination or simplification, whether in substance or in principle, not deviated from the spirit of the present invention, is replacement or substitution of equivalent effect and falls within the scope of protection of the present invention.

What is claimed is:

1. A showerhead with spray mode selecting function comprising a handle portion and a showerhead portion, wherein the handle portion provides a water passage for water to flow from a water source to the showerhead portion, and is disposed with a mode selecting means which couples with a first end of a pushrod; the showerhead portion comprises:
an actuating means which is actuated by a second end of the pushrod to rotate around an axis between a first position and a second position, and is biased by a first biasing means towards the first position;
a limiting disc which is actuated by the actuating means to rotate around the axis and disposed with an actuating magnet on a top side thereof; rotation of the actuating means displaces the actuating magnet among a plurality of evenly spaced predefined positions; each of the predefined positions is associated with one spray mode, and distance between the adjacent predefined positions corresponds to distance between the first position and the second position of the actuating means;
a diverting member which comprises a water inlet which is in communication with the water passage, a diverting member cavity which is in communication with the water inlet, a plurality of water chambers sealed from each other;
each of the water chamber comprises a water inlet pore which is in communication with the diverting member cavity, a water chamber cavity which is in communication with the water inlet pore, a water outlet which is in communication with one or more specific water channels for delivering water out from the showerhead in a specific spray mode, a controlling member which is in selective communication with the water chamber cavity and the water outlet, and a chamber magnet;
the chamber magnet is fixedly secured to the controlling member and attracted by the actuating magnet to move together with the controlling member between a blocking position where water is blocked by the controlling member from flowing from the water chamber cavity to the water outlet and a non-blocking position where water is allowed to flow from the water chamber cavity to the water outlet; a second biasing means biases the chamber magnet towards the blocking position.

2. The showerhead as in claim 1, wherein the mode selecting means comprises a slide button exposed on an outer surface of the handle portion, and a sliding plate fixedly engaged with the slide button and disposed inside the handle portion; the sliding plate has an end which couples with the first end of the pushrod; sliding the slide button forward moves the sliding plate forward towards the pushrod and thus push the pushrod forward.

3. The showerhead as in claim 1, wherein the mode selecting means comprises a push button exposed on an outer surface of the handle portion, a first connecting rod, a second connecting rod and a spring; the first connecting rod has a first end which is pivotally connected at a pivot point with a first end of the second connecting rod; the first connecting rod has a second end which is fixedly disposed inside the handle portion; the second connecting rod has a second end which is movably and abuts against the first end of the pushrod; the push button couples with the pivot point so that depression of the push button causes the second end of the second connecting rod to move forward towards the pushrod and thus push the pushrod forward; the spring is disposed inside the handle portion and abuts against a bottom side of the push button to bias the push button towards a non-depressed position.

4. The showerhead as in claim 1, wherein the actuating means is in form of a ratchet wheel with an actuating rod extended therefrom; the actuating rod has a free end which abuts against the second end of the pushrod; the ratchet wheel is disposed with a plurality of uniform ratchet teeth, each of the ratchet teeth is asymmetrical with an apex and a root.

5. The showerhead as in claim 4, wherein the first biasing means is a spring wound around a bottom side of the ratchet wheel.

6. The showerhead as in claim 4, wherein the limiting disc has a bottom side which is evenly disposed with a plurality of sloping slots corresponding to the plurality of ratchet teeth; each of the sloping slots has a deep end which protrudes upward to the top side of the limiting disc and a shallow end; each of the sloping slots engages with one of the ratchet teeth such that the apex of the ratchet tooth abuts against the deep end of the sloping slot.

7. The showerhead as in claim 1, wherein the top side of the limiting disc is fixedly disposed with an actuating magnet seat for receiving the actuating magnet

8. The showerhead as in claim 1, wherein the diverting member is formed by an upper diverting member and a lower diverting member; the water inlet is provided at the upper diverting member; the upper diverting member and the lower diverting member are disposed with walls for defining the diverting chamber cavity and the water chamber cavity of the water chambers.

9. The showerhead as in claim 8, wherein a first intermediate diverting member is provided between the upper diverting member and the lower diverting member for water sealing each of the water chambers and for supporting a second intermediate diverting member in each of the water chambers; the water inlet pore and the water outlet are disposed in the second intermediate diverting member.

10. The showerhead as in claim 8, wherein the upper diverting member is provided with an upward recess for receiving the chamber magnet in each of the water chambers.

11. The showerhead as in claim 10, wherein the second biasing means is a spring disposed in the upward recess.
